(19) United States
(12) Patent Application Publication
(10) Pub. No.: US 2026/0302711 A1
(43) Pub. Date: Oct. 1, 2026

(54) HYBRID OPTICAL AMPLIFIER

(71) Applicant: 1FINITY Inc., Kawasaki-shi (JP)

(72) Inventor: Youichi AKASAKA, Plano, TX (US)

(73) Assignee: 1FINITY Inc., Kawasaki-shi (JP)

(21) Appl. No.: 19/094,539

(22) Filed: Mar. 28, 2025

(51) Int. Cl. H01S 3/067; H01S 3/094; H01S 3/10; H01S 3/16; H01S 3/23

(52) U.S. Cl. CPC H01S 3/06716; H01S 3/094003; H01S 3/10023; H01S 3/1608; H01S 3/1695; H01S 3/2316

(57) ABSTRACT

According to an aspect of an embodiment, a method to amplify a signal includes obtaining an optical signal to be amplified. The method further includes obtaining a first optical pump signal from a first optical pump. The optical signal and the first optical pump signal may be multiplexed onto an erbium-doped fiber by a first optical coupler. In some embodiments, the erbium-doped fiber may be configured to perform amplification of optical waveforms within a first wavelength range to generate a first amplified optical signal. The method may further include obtaining a second optical pump signal. The first amplified optical signal and the second optical pump signal may be multiplexed, by a second optical coupler, onto a bismuth-doped optical fiber. In some embodiments, the bismuth-doped optical fiber may be configured to perform amplification of the optical waveforms within the first wavelength range to generate a second amplified optical signal.

### FIELD

The embodiments discussed in the present disclosure are related to optical signal amplification using a hybrid optical amplifier including an erbium doped fiber optical amplifiers (EDFAs) and bismuth doped fiber amplifiers (BDFAs).

### BACKGROUND

Telecommunications systems, cable television systems and data communication networks use optical networks to convey information between remote points. In an optical network, information is conveyed in the form of optical signals through optical fibers or other optical media. The optical networks may include various components such as amplifiers, dispersion compensators, multiplexer/demultiplexer filters, wavelength selective switches, couplers, etc. configured to perform various operations within the optical network. Further, optical amplification may be used to amplify optical signals that propagate through optical networks.

The subject matter claimed herein is not limited to embodiments that solve any disadvantages or that operate only in environments such as those described above. Rather, this background is only provided to illustrate one example technology area where some embodiments described herein may be practiced.

### SUMMARY

According to an aspect of an embodiment, a method to amplify a signal includes obtaining an optical signal to be amplified. The method further includes obtaining a first optical pump signal from a first optical pump. The optical signal and the first optical pump signal may be multiplexed onto an erbium-doped fiber by a first optical coupler. In some embodiments, the erbium-doped fiber may be configured to perform amplification of optical waveforms within a first wavelength range to generate a first amplified optical signal. The method may further include obtaining a second optical pump signal. The first amplified optical signal and the second optical pump signal may be multiplexed, by a second optical coupler, onto a bismuth-doped optical fiber. In some embodiments, the bismuth-doped optical fiber may be configured to perform amplification of the optical waveforms within the first wavelength range to generate a second amplified optical signal.

The object and advantages of the embodiments will be realized and achieved at least by the elements, features, and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

Example embodiments will be described and explained with additional specificity and detail through the use of the accompanying drawings in which:

FIG. 1A illustrates an example embodiment of a hybrid optical amplifier, in accordance with one or more embodiments of the present disclosure;

FIG. 1B illustrates an example erbium-doped fiber amplifier, in accordance with one or more embodiments of the present disclosure;

FIG. 1C illustrates an example bismuth-doped fiber amplifier, in accordance with one or more embodiments of the present disclosure;

FIG. 2 illustrates an example attenuation profile of a filter, in accordance with one or more embodiments of the present disclosure;

FIG. 3 illustrates another example gain profile, in accordance with one or more embodiments of the present disclosure;

FIG. 4 is a flow chart of an example method of amplifying an optical signal, in accordance with one or more embodiments of the present disclosure; and

FIG. 5 illustrates a block diagram of an example computing system that may be used with the hybrid optical amplifier, in accordance with one or more embodiments of the present disclosure.

### DETAILED DESCRIPTION

Optical networks may include nodes that may be configured to communicate data to each other via optical signals carried by optical fibers. As the optical signals travel via the optical fibers, the optical signals experience attenuation, or the gradual decrease in signal strength. The attenuation happens naturally due to different factors such as scattering, absorption, and imperfections in the optical fibers. As the optical signals propagate, the optical signals may weaken due to the attenuation, which may lead to loss of data integrity and quality. The optical signals may experience increased attenuation in long-distance communications.

In some circumstances, optical amplifiers may be used to restore or strengthen the quality and/or strength of the optical signals. In general, optical amplifiers may provide amplifications to the optical signals directly without converting the optical signals to electrical signals. Such amplification may permit the optical signals to remain strong enough to reach destinations with reduced degradation. Some examples of optical amplifiers may include fiber amplifiers (e.g., erbium-doped fiber amplifiers (EDFAs), bismuth-doped fiber amplifiers (BDFAs)), Raman amplifiers, Semiconductor Optical Amplifiers (SOAs), etc.

Fiber amplifiers are commonly implemented because fiber amplifiers generally provide low noise amplification, which may help maintain the integrity of the optical signals. Fiber amplifiers may provide long-distance capability with low cost and simple operation. Additionally, fiber amplifiers may amplify a wide range of wavelengths, making fiber amplifiers suitable for diverse communication bands. In particular, fiber amplifiers, such as EDFAs, may provide low noise amplification for optical signals in the conventional band (C-band) which approximately ranges from 1530 nanometers (nm) to 1565 nm and a long-wavelength band (L-band) which approximately ranges from 1565 nm to 1600 nm.

As the demand for high-capacity data transmission continues to grow, the need for more efficient and extended bandwidth in optical communications systems has become increasingly critical. The C-band and L-band have been the primary wavelength used for optical amplification in fiber-optic networks duet to the optimal characteristics, such as low signal attenuation and favorable fiber properties (e.g., gain spectrum of fibers). However, such characteristics have led to congested use of the C-band and the L-band. With the congestion of the C-band and the L-band, a need for utilizing other optical communication bands, such as a short-wavelength band (S-band) which approximately ranges from 1495 nm to 1530 nm, has increased. With the S-band below the C-band, the S-band may provide an opportunity to expand the bandwidth available for optical transmission.

Different types and/or combination of optical amplifiers have been used to attempt to amplify the signals in the S-band. For example, Tunable Dopant Fiber Amplifiers (TDFAs), SOAs, discrete Raman Amplifiers, etc. have been implemented with respect to the S-band. However, TDFAs, SOAs, and Raman amplifiers suffer from issues, such as reliability, output power, fiber nonlinearity distortion, respectively.

Another approach includes an optical amplifier that includes a Bismuth-Doped Fiber Amplifier (BDFA) followed by an EDFA. For instance, the BDFA and the EDFA have been cascaded such that the BDFA may amplify the signals in the shorter wavelength range of S-band and the EDFA may amplify the signals in the longer wavelength range of S-band. However, the efficiency of such amplifiers has been limited due to nature of the fiber amplifiers (e.g., higher noise figure of BDFA and high noise figure of the EDFA in the shorter wavelength range of S-band).

According to one or more embodiments of the present disclosure, a hybrid optical amplifier (“optical amplifier”) may include multiple stages of amplification. For example, the optical amplifier may include a first stage corresponding to a EDFA and a second stage corresponding to a BDFA. The EDFA may be configured to come before the BDFA to improve efficiency of the optical amplifier, with the EDF of the EDFA configured such that the gain profile of the EDF expands across the S-band. Such configuration of the optical amplifier may amplify optical signals in S-band with improved noise performance compared to existing approaches.

Embodiments of the present disclosure will be explained with reference to the accompanying drawings.

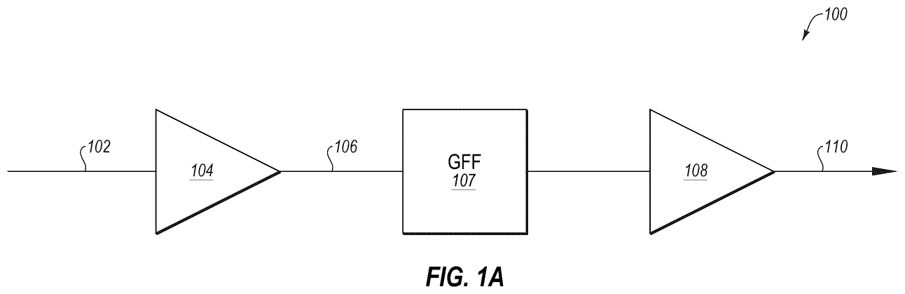

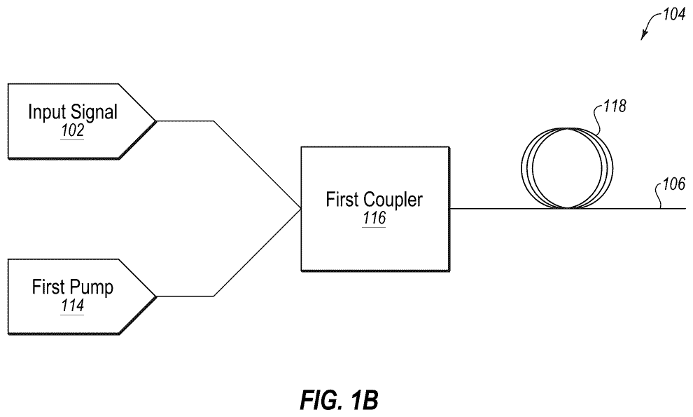

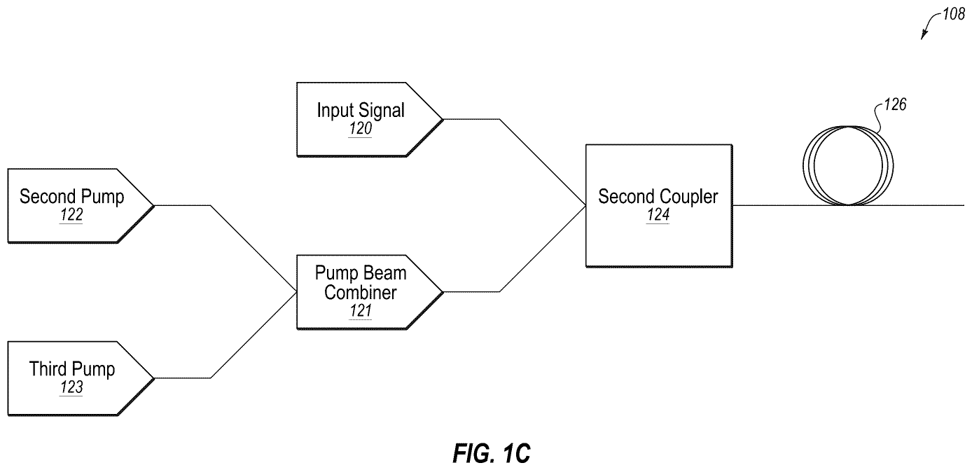

FIG. 1A illustrates an example hybrid optical amplifier 100 (amplifier 100), in accordance with at least one embodiment of the present disclosure. In general, the amplifier 100 may be configured to amplify optical signals to generate amplified optical signals such that the optical signals may communicated over communication systems. For example, in the illustrated example, the amplifier 100 may be configured to receive and amplify an optical signal 102 to generate a second amplified optical signal 110. In some embodiments, the amplifier 100 may be implemented as part of an optical network, such as a long-haul optical network, a dense wavelength division multiplexing network, an optical metropolitan area network (MAN), an optical access network, an optical transport network, etc.

In some embodiments, the optical signal 102 may include any optical signal configured to carry data. For example, the optical signal 102 may include an optical signal generated by a light emitting diode (LED), a laser such as a laser diode, having data modulated thereon and/or other similar optical signals. In some embodiments, the optical signal 102 may be generated by a transmitting source, such as an optical transmitter, configured to convey data and/or information over an optical network.

In some embodiments, the optical signal 102 may carry data within wavelength ranges corresponding to optical signal communication bands. For example, the optical signal 102 may carry data within a wavelength range corresponding to what may be commonly referred to as the S-band of optical signal communications, which may be approximately 1495 nm to 1530 nm.

In some embodiments, the amplifier 100 may be a hybrid amplifier including multiple amplifiers. For example, the amplifier 100 may include multiple amplifiers that are cascaded. For example, the amplifier 100 may include a first amplifier 104 and a second amplifier 108. In the present disclosure, cascading amplifiers may refer to connecting multiple amplifiers in a sequence along a communication link to amplify the optical signal 102 at various points along the communication link. For instance, the first amplifier 104 may be configured to amplify the optical signal 102 to generate a first amplified signal 106. The second amplifier 108 may be configured to amplify the first amplified signal 106 to generate a second amplified optical signal 110. In some embodiments, the first amplifier 104 and the second amplifier 108 may be connected or cascaded such that a distance between the first amplifier 104 and the second amplifier 108 is insignificant. For example, the first amplifier 104 and the second amplifier 108 may be connected by a patch fiber. In some embodiments, the distance between the first amplifier 104 and the second amplifier 108 or the length of the patch fiber may be less than one meter.

In some embodiments, the amplifier 100 may include different types of amplifiers. For example, in some embodiments, the first amplifier 104 may be or include an EDFA, and the second amplifier 108 may be or include a BDFA. For example, the EDFA may first amplify the optical signal 102 to generate the first amplified signal 106, and the BDFA may amplify the first amplified signal 106 to generate the second amplified optical signal 110. In some embodiments, the EDFA corresponding to the first amplifier 104 may be described in further detail with respect to FIG. 1B of the present disclosure.

For example, with reference to FIG. 1B, the first amplifier 104 may include a first pump 114, a first coupler 116, and a first optical fiber 118. In some embodiments, the first pump 114 may be optically coupled to the first coupler 116. In these and other embodiments, the first pump 114 may be configured to generate an optical pump signal and to provide the optical pump signal to the first coupler 116. In some embodiments, any type of optical pump may be used. For example, the first pump 114 may be a laser diode, an arc lamp, a flash lamp, among others. The optical pump signal may include a wavelength different than the wavelengths of the optical signal 102. For instance, the optical pump signal may not include any wavelength that is used by the optical signal 102. As an example, the optical pump signal may have wavelengths of 810 nm, 980 mm, 1480 nm, among others.

In some embodiments, the first amplifier 104 may be configured for backward pumping of the first optical fiber 118. For example, in some embodiments, the first pump 114 may be placed such that the optical pump signal is provided to the first optical fiber 118 from the output end or the end opposite of the end at which the first optical fiber 118 receives the input signal 102. For instance, the input signal 102 may enter the first optical fiber 118 at an input end and the optical pump signal may enter the first optical fiber 118 at the output end. In these and other embodiments, the input signal 102 and the optical pump signal may travel in opposite directions and interact within the first optical fiber 118.

Additionally or alternatively, in some embodiments, the first amplifier 104 may be configured for bi-directional pumping of the first optical fiber 118. For example, the first amplifier 104 may include an additional optical pump in addition to the first pump 114. For example, the additional pump may be placed on the output side of the first optical fiber 118. In these and other embodiments, the optical pump signals may be provided to the first optical fiber 118 from both the input side and the output side. Such configuration may improve efficiency of the first amplifier 104 as the optical pump signals may be utilized in both directions.

In some embodiments, the first coupler 116 may be optically coupled to the first pump 114 and the first optical fiber 118. In these and other embodiments, the first coupler 116 may be configured to obtain and to multiplex multiple signals onto the first optical fiber 118. For example, the first coupler 116 may be configured to obtain the optical signal 102 and the optical pump signal and to multiplex and/or combine the optical signal 102 and the optical pump signal to the first optical fiber 118. As an example, the first coupler 116 may be a wavelength division multiplexer (WDM). Alternately or additionally, the first coupler 116 may include one or more optical components, fused optical fibers, or waveguides to multiplex the optical signal 102 and the optical pump signal.

In some embodiments, the first amplifier 104 may be configured to provide a gain to the optical signal 102 such that the power of the optical signal 102 may increase as the optical signal 102 passes through the first amplifier 104. For example, the first optical fiber 118 may be configured to amplify the optical signal 102 using the optical pump signal. For example, an interaction between the ions of the first optical fiber 118 and the optical pump signal may cause emission of energy within the first optical fiber 118 which may be used to amplify the optical signal 102.

In some circumstances, the amplification of the optical signal 102 may vary based on the wavelengths of the optical signal 102. For example, signals at different wavelengths may experience different levels of amplifications within the first optical fiber 118. In some instances, such varying amplification may be caused due to the gain profile of the first optical fiber 118 in which the first optical fiber 118 applies different amounts of amplification to signals at different wavelengths. The gain profile may refer to the distribution of amplification power across different wavelengths that the first optical fiber 118 may amplify.

In some embodiments, the first optical fiber 118 may be manufactured and/or adjusted such that the first optical fiber 118 applies the most amplification to the wavelength range corresponding to the optical signal 102. For example, in some embodiments, the optical signal 102 may have signals carrying data within the S-band of optical communications. In such instances, the first optical fiber 118 may be configured to amplify the signals within the S-band such that the optical signal 102 may be transmitted over a distance.

In some embodiments, the gain profile of the first optical fiber 118 may be defined and/or modified based on the length of the first optical fiber 118. For example, the length of the first optical fiber 118 may be modified such that the first optical fiber 118 may provide amplification for the S-band. In some embodiments, the length of the first optical fiber 118 may be determined such that the noise in other wavelengths (e.g., the C-band and L-band) may be reduced.

In some embodiments, a shorter erbium-doped fiber may provide gain for a wider range of wavelengths. For instance, the fiber may not be long enough to provide significant amplification across the full spectrum of interest. Contrastingly, longer fiber may provide more amplification over a narrower range of wavelengths. In these and other embodiments, the length of the first optical fiber 118 may be defined such that the first optical fiber 118 provides amplification for the S-band. For example, in some embodiments, the length of the first optical fiber 118 may be less than 15 m. In some embodiments, the first optical fiber 118 may be less than 10 m. More preferably, the length of the first optical fiber 118 may be between 2 m and 5 m. For example, in some embodiments, the first optical fiber 118 may be 2.5 m.

In these and other embodiments, the gain profile of the first optical fiber 118 may be wider such that the amplification is expanded to amplify signals in the wavelengths corresponding to the S-band. For instance, longer erbium-doped fibers may have limited gain bandwidth such that only the signals in the C-band and/or the L-band are amplified. Reducing the length of the erbium-doped fibers may expand the gain bandwidth to include the wavelengths in the S-band.

In some embodiments, the first amplifier 104 may include an isolator coupled between the first coupler 116 and the first optical fiber 118. The isolator may be configured to direct optical signals in a certain direction. For example, the isolator may direct the optical signals from the first coupler 116 to the first optical fiber 118. The isolator may block or redirect any signals from traveling backward toward the first coupler 116. The isolator may reduce back-reflected light which may cause undesired optical feedback that may lead to oscillations or instabilities in the amplifier.

FIG. 1C illustrates an example embodiment of a BDFA, in accordance with one or more embodiments of the present disclosure. For example, FIG. 1C may illustrate an example embodiment of the second amplifier 108. In some embodiments, the second amplifier 108 may include a pump beam combiner 121, a second pump 122, a third pump 123, a second coupler 124, and a second optical fiber 126. In some embodiments, the second optical fiber 126 may be or include a bismuth-doped fiber.

In some embodiments, the second amplifier 108 may be configured to further amplify the first amplified signal 106 from the first amplifier 104. For example, the input signal 120 may correspond to the first amplified signal 106 that is output from the first amplifier 104.

In some embodiments, the pump beam combiner 121 may be configured to combine and/or relay one or more pump signals to the second coupler 124. For example, in some embodiments, the second pump 122 may be configured to generate a second pump signal to be provided to the second coupler 124. The second coupler 124 may combine the input signal 120 and the second pump signal onto the second optical fiber 126. In some embodiments, any type of optical pump may be used for the second pump 122. For example, the second pump 122 may be a laser diode, an arc lamp, a flash lamp, among others. The optical pump signal may include a wavelength different than the wavelengths of the input signal 120. For instance, the second pump signal may not include any wavelength that is used by the input signal 120.

In some embodiments, the second amplifier 108 may be configured for backward pumping of the second optical fiber 126. For example, in some embodiments, the pump beam combiner 121, the second pump 122, and the third pump 123 may be placed such that the optical pump signal is provided to the second optical fiber 126 from the output end or the end opposite of the end at which the second optical fiber 126 receives the first amplified signal 106. For instance, the first amplified signal 106 may enter the second optical fiber 126 at an input end or side and the optical pump signal may enter the second optical fiber 126 at the output end or side. In these and other embodiments, the first amplified signal 106 and the optical pump signal may travel in opposite directions and interact within the second optical fiber 126.

Additionally or alternatively, in some embodiments, the second amplifier 108 may be configured for bi-directional pumping of the second optical fiber 126. For example, the second amplifier 108 may include an additional optical pump in addition to the second pump 122 and the third pump 123. For example, the additional pump may be placed on the output side of the second optical fiber 126. In some embodiments, the additional pump may include a combination of multiple optical pumps with an additional pump beam combiner. In these and other embodiments, the optical pump signals may be provided to the second optical fiber 126 from both the input side and the output side. Such configuration may improve efficiency of the second amplifier 108 as the optical pump signals may be utilized in both directions.

In some embodiments, the wavelengths of the second pump signal may be determined based on the characteristics of the second optical fiber 126. For example, the second optical fiber 126 (e.g., a bismuth-doped fiber) may have attenuation characteristics with attenuation peaks around 1400 nm. For example, due to intrinsic fiber properties such as the material absorption and scattering losses that may tend to increase around 1400 nm, the second optical fiber 126 may have the attenuation peak around the range. In some instances, the second pump signal with the 1400 nm wavelength may provide an effective pump wavelength for exciting bismuth ions of the second optical fiber 126. However, as 1400 nm is close to the S-band corresponding to the input signal 120 and also corresponds to the attenuation peak, the second pump signal may be defined such that the wavelengths of the second pump signal is shifted from 1400 nm. For example, the second pump signal may have wavelengths between 1300 nm and 1400 nm.

In some instances, such longer wavelengths may not provide enough power for the second optical fiber 126 to amplify the input signal 120. In these and other embodiments, the second amplifier 108 may include multiple optical pumps configured to generate multiple pump signals which may be combined. For example, the pump beam combiner 121 may be configured to combine pump signals from the second pump 122 and the third pump 123. The second pump 122 and the third pump 123 may each generate an optical pump signal to be combined. For example, the second pump 122 may generate a pump signal with a wavelength between 1300 nm and 1400 nm, and the third pump may also generate a pump signal with a wavelength between 1300 nm and 1400 nm. The pump beam combiner 121 may be configured to combine these multiple pump signals prior to providing the combined pump signal to the second coupler 124.

For example, in some embodiments, the pump beam combiner 121 may be configured to combine the pump signals from the second pump 122 and the third pump 123, such that enough pump power may be provided to the second optical fiber 126. While discussed with respect to two optical pumps, the second amplifier 108 may include additional optical pumps that may generate pump signals to be combined. In some embodiments, the multiple pump signals may have varying wavelengths. For example, the second pump 122 may generate a pump signal at 1330 nm and the third pump 123 may generate a pump signal at 1341 nm. While the second amplifier 108 is illustrated with the pump beam combiner 121, in some embodiments, the second amplifier 108 may have a single pump configured generate the pump signal to be multiplexed onto the second optical fiber 126 using the second coupler 124. In some embodiments, the pump beam combiner 121 may be configured to combine any other suitable number of optical pump signals.

In some embodiments, the second optical fiber 126 may include different types of bismuth fibers. In particular, the second optical fiber 126 may include different host materials. The host materials may refer to the base material or core material in which the active dopant (e.g., the bismuth) is embedded. The host material may provide optical characteristics and structural properties for the optical fibers to be used in optical amplifiers. For example, the host materials may affect transmission characteristics, optical properties, mechanical properties, etc. for the optical fibers. In some embodiments, the second optical fiber 126 may include a germanium (Ge)-doped silica as the host material. In these and other embodiments, the Ge-host may help shift the gain peak of the second optical fiber 126 to longer wavelengths. For example, the Ge-host may help shift the gain peak from around 1400 nm to around 1460 nm. Such shift may help the second optical fiber 126 to provide more amplification for optical signals in the S-band.

In some embodiments, the second amplifier 108 may include one or more isolators. For example, in some embodiments, the second amplifier 108 may include a second isolator coupled between the second coupler 124 and the second optical fiber 126. The second isolator may be configured to direct optical signals in a certain direction. For example, the isolator may direct the optical signals from the second coupler 124 to the second optical fiber 126. The second isolator may block or redirect any signals from traveling backward toward the second coupler 124.

Additionally or alternatively, the second amplifier 108 may include a third isolator that may be coupled to an output side of the second optical fiber 126. The third isolator may be configured to direct amplified signals away from the second optical fiber 126. The third isolator may reduce back-reflected light which may cause undesired optical feedback that may lead to oscillations or instabilities in the amplifier. In some embodiments, the isolators in the present disclosure may include any suitable types of hardware or components that may direct optical signals in a direction. For example, the isolators may be or include circulators.

Returning to FIG. 1A, in some embodiments, the amplifier 100 may include a gain flattening filter (GFF) 107. For example, in some embodiments, the GFF 107 may be coupled between the first amplifier 104 and the second amplifier 108. In some embodiments, the GFF 107 may be configured to reduce the noise present in wavelength ranges outside of the wavelength range corresponding to the optical signal 102 and/or the first amplified signal 106. For example, the GFF 107 may be configured to flatten or reduce the noise outside of the S-band.

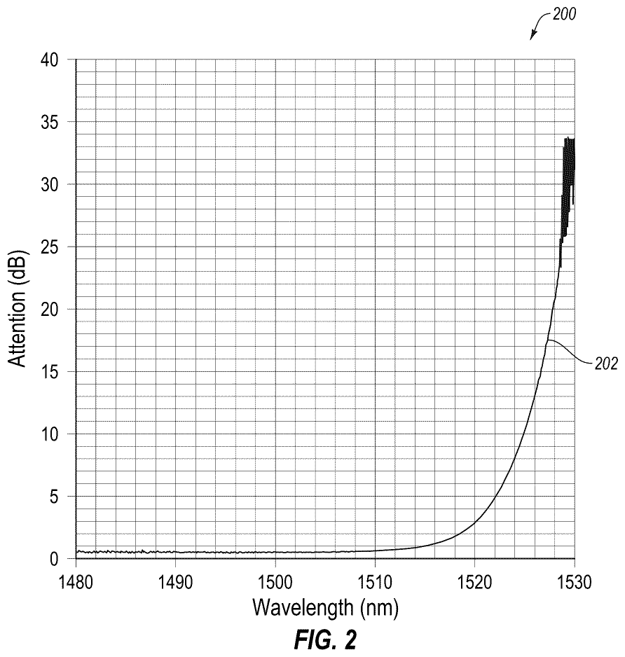

For example, in some embodiments, the GFF 107 may be configured to compensate for amplification of noise signals by the first amplifier 104 or the EDFA in the C-band and the L-band. For example, FIG. 2 includes a diagram 200 illustrating an attenuation profile 202 of a gain flattening filter that may be used in the amplifier 100 of FIG. 1, in accordance with one or more embodiments of the present disclosure. In some embodiments, the attenuation profile 202 may begin to increase outside of the S-band. For example, the attenuation profile 202 may begin to increase around 1525 nm.

With reference back to FIG. 1A, the GFF 107 may compensate for the amplification of noise in the C-band and the L-band that the EDFA may naturally apply to the optical signal 102. For instance, the first amplifier 104 may naturally apply amplification to the C-band and the L-band due to optical characteristics of EDF. In these and other embodiments, the GFF 107 may reduce the noises in the C-band and the L-band prior to second amplification by the second amplifier 108. Such an implementation may reduce noise amplified by the second amplifier 108 (e.g., the BDFA). Additionally or alternatively, in some embodiments, the GFF 107 may be placed after the second amplifier 108. For example, the GFF 107 may be configured to reduce the noise amplified by both the first amplifier 104 and the second amplifier 108. In some embodiments, the amplifier 100 may include multiple GFFs. For example, the amplifier 100 may include a first GFF between the first amplifier 104 and the second amplifier 108, and a second GFF after the second amplifier 108.

Modifications, additions, or omissions may be made to the amplifier 100, the first amplifier 104, and/or the second amplifier 108 without departing from the scope of the present disclosure. For example, in some embodiments, the amplifier 100 may include any number of other components that may not be explicitly illustrated or described.

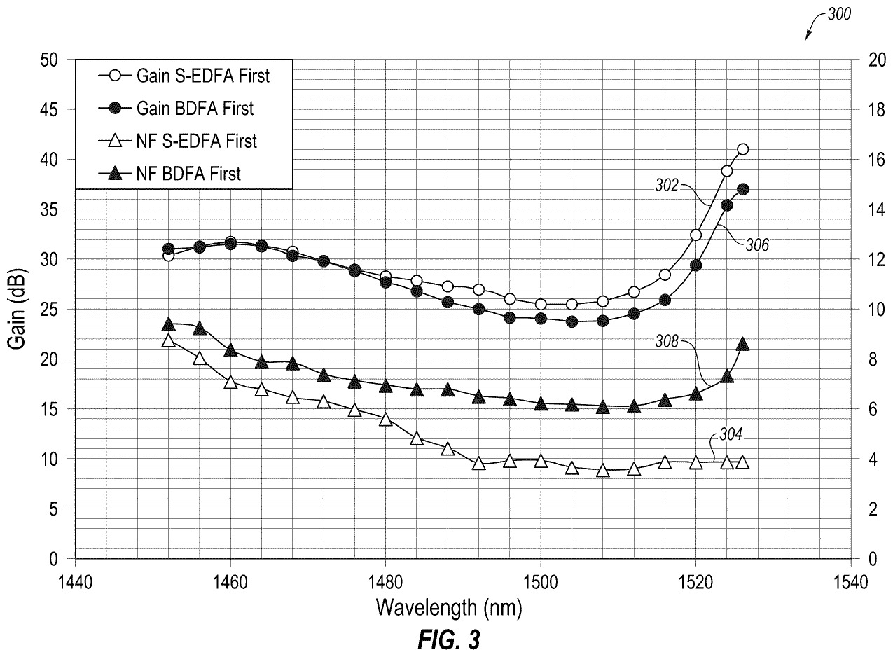

FIG. 3 includes a diagram 300 illustrating a first gain profile 302 of a hybrid optical amplifier, in accordance with one or more embodiments of the present disclosure. For example, the diagram 300 may illustrate a gain profile of an optical amplifier such as the amplifier 100 of FIG. 1 that includes an EDFA (e.g., the first amplifier 102) and an BDFA (e.g., the second amplifier 108) with the EDFA placed before the BDFA. In some embodiments, the diagram 300 may include the first gain profile 302 of the optical amplifier and a first noise profile 304 for the amplifier (e.g., the amplifier 100 of FIG. 1). Additionally, the diagram 300 illustrates a second gain profile 306 and a second noise profile 308 for a conventional hybrid amplifier including a BDFA and an EDFA with the BDFA placed before the EDFA.

With conventional hybrid amplifiers, a BDFA is placed before an EDFA. The BDFA may be configured to provide amplification for broader wavelength ranges, including the S-band. The conventional design uses the BDFA to first provide amplification for optical signals in the S-band. The EDFA is used to further amplify the signals amplified by the BDFA. However, due to the natural characteristics of the EDFA, the EDFA amplifies signals or noises in the C-band along with the signals in the S-band. For example, the second noise profile 308 increases as the second gain profile 306 increases. The noise figure in the S-band is around 6 dB, and the noise in the C-band increases further. Such relationships between the second noise profile 308 and the second gain profile 306 place limitations on how much gain can be applied to the S-band using the conventional hybrid amplifiers, as the noise amplification in the C-band degrades the quality of optical signals in the S-band.

Contrastingly, the hybrid amplifier, in accordance with one or more embodiments of the present disclosure, provides gains for the S-band at the same or improved level from the conventional design while providing improved (e.g., lower) noise figure. For example, the first noise profile 304 shows lower noise figures than the second noise profile 308.

In general, placing the EDFA first generates higher noise in the S-band compared to placing the BDFA first in shorter wavelength range of S-band. For instance, placing the EDFA before the BDFA may generate a noise figure around 15 dB which is higher than 6 dB produced with the BDFA placed before the EDFA in shorter wavelength range of S-band as the EDFA has absorption band around 1480 nm. Such increased noise figure generally discourages users from the implementation of having the EDFA before the BDFA. However, the hybrid amplifier according to embodiments of the present disclosure reduces the noise figure in the S-band with the EDFA placed before the BDFA by selecting shorter EDF length with high inversion population.

For instance, a gain profile of an EDFA may be modified such that the gain profile expands across wider range of wavelengths, including the S-band. The EDFA may provide first amplification to optical data signals in the wavelength range corresponding to the S-band. The amplified optical signal from the EDFA may be further amplified by the BDFA. The BDFA may provide additional amplification to the optical signals in the S-band with low noise profile. For instance, the BDFA, which may include a bismuth-doped fiber configured to amplify signals in the S-band, may further amplify the optical signals amplified by the EDFA and maintain the noise figures low. For instance, as the BDFA provides lower gain in the C-band and the L-band, the BDFA may not amplify the noises present in the C-band the and L-band as much as the optical signals in the S-band.

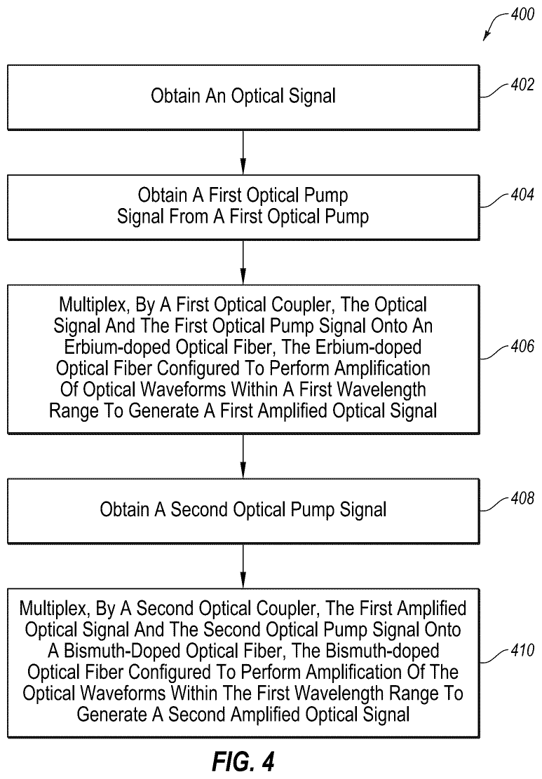

FIG. 4 is a flow chart of an example method 400 of performing amplification with respect to an optical signal using a hybrid optical amplifier, arranged in accordance with at least one embodiment of the present disclosure. In some embodiments, the method 400 may be performed using an optical amplifier such as the hybrid optical amplifier 100, the first amplifier 104, and/or the second amplifier 108 of FIGS. 1A-1C.

In some embodiments, the method 400 may begin at block 402. At block 402, an optical signal may be obtained. The optical signal may be or include any optical signal configured to carry data. For example, the optical signal may include an optical signal generated by a light emitting diode (LED), a laser such as a laser diode, having data modulated thereon and/or other similar optical signals. In some embodiments, the optical signal may be generated by a transmitting source, such as an optical transmitter, configured to convey data and/or information over an optical network. In some embodiments, the optical signal may carry data within wavelength ranges corresponding to optical signal communication bands. For example, the optical signal may carry data within a wavelength range corresponding to what may be commonly referred to as the S-band of optical signal communications, which may be approximately 1495 nm to 1530 nm.

At block 404, a first optical pump signal may be obtained from a first optical pump. In some embodiments, the first optical pump may include any type of optical pump that may generate the first optical pump signal. For example, the first optical pump may be a laser diode, an arc lamp, a flash lamp, among others. In some embodiments, the first optical pump signal may include a wavelength different than the wavelengths of the optical signal. For instance, the first optical pump signal may not include any wavelength that is used by the optical signal. As an example, the optical pump signal may have wavelengths of 810 nm, 980 mm, 1480 nm, among others.

At block 406, the optical signal and the first optical pump signal may be multiplexed, by a first optical coupler, onto an erbium-doped optical fiber (e.g., the first optical fiber 118 of FIG. 1B). In some embodiments, the erbium-doped optical fiber may be configured to perform amplification of optical waveforms within a first wavelength range to generate a first amplified optical signal. In some embodiments, the first wavelength range may correspond to the S-band of optical communications. For example, the erbium-doped optical fiber may amplify the data signals in the optical signal.

In some embodiments, a length of the erbium-doped optical fiber may be adjusted such that the erbium-doped optical fiber is configured to amplify the signals within the first wavelength range. For example, adjusting the length of the erbium-doped optical fiber may shift the gain profile of the erbium-doped optical fiber. For example, in some embodiments, the length of the erbium-doped optical fiber may be between two meters and five meters. In some embodiments, the length of the erbium-doped optical fiber may be adjusted such that the erbium-doped optical fiber has a positive gain across the bandwidth of the S-band. In some embodiments, the length of the optical fiber may be about 2.5 meters.

At block 408, a second optical pump signal may be obtained. In some embodiments, the second optical pump signal may be obtained from a second optical pump. In some embodiments, the second optical pump signal may be a combination of optical pump signals from a second optical pump and a third optical pump. For example, the optical pump signals from the second optical pump and the third optical pump may be combined, using a combiner to generate the second optical pump signal. In some embodiments, the optical pump signals from the second optical pump and the third optical pump may include wavelengths shorter than 1400 nanometers.

At block 410, the first amplified optical signal and the second optical pump signal may be multiplexed, by a second optical coupler, onto a bismuth-doped optical fiber (e.g., the second optical fiber 124 of FIG. 1C). In some embodiments, the bismuth-doped optical fiber may be configured to perform amplification of the optical waveforms within the first wavelength range to generate a second amplified optical signal. In some embodiments, the bismuth-doped optical fiber may further amplify the first amplified optical signal. In some embodiments, the bismuth-doped optical fiber may include different host types. For example, in some embodiments, the bismuth-doped optical fiber may be a germanium (Ge)-host bismuth doped optical fiber. For example, the Ge-host bismuth doped optical fiber may provide amplification for the optical waveforms within the first wavelength range.

Modifications, additions, or omissions may be made to the method 400 without departing from the scope of the present disclosure. For example, the outlined steps and operations are only provided as examples, and some of the steps and operations may be optional, combined into fewer steps and operations, or expanded into additional steps and operations without detracting from the essence of the disclosed embodiments.

For example, in some embodiments, the method 400 may further include, prior to block 410, attenuating, using a filter, signals in a second wavelength range of the first amplified optical signal. For example, the filter may be configured to attenuate signals in a C-band of optical communications and/or an S-band of optical communications. The filter may reduce the noise in the first amplified optical signal prior to further amplification by the bismuth-doped optical fiber, such that the noise present in the second wavelength range may not be amplified by the bismuth-doped optical fiber. In some embodiments, the filter may correspond to the gain flattening filter 107 of FIG. 1A.

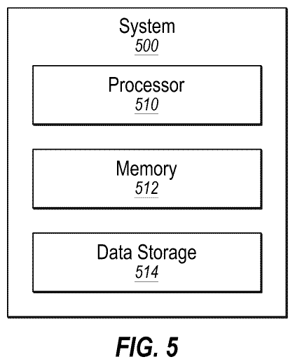

FIG. 5 illustrates a block diagram of an example computing system 500 that may be used with respect an optical amplifier, according to at least one embodiment of the present disclosure. For example, the computing system 500 may be used to adjust a pumping wavelength of a pump source of the EDFA or the BDFA (e.g., one or more of the pump sources described above) and/or a frequency response of a filter of the EDFA or the BDFA (e.g., one or more of the filters described above).

The computing system 500 may include a processor 510, a memory 512, and a data storage 514. The processor 510, the memory 512, and the data storage 514 may be communicatively coupled.

In general, the processor 510 may include any suitable special-purpose or general-purpose computer, computing entity, or processing device including various computer hardware or software modules and may be configured to execute instructions stored on any applicable computer-readable storage media. For example, the processor 510 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 5, the processor 510 may include any number of processors configured to, individually or collectively, perform or direct performance of any number of operations described in the present disclosure. Additionally, one or more of the processors may be present on one or more different electronic devices, such as different servers.

In some embodiments, the processor 510 may be configured to interpret and/or execute program instructions and/or process data stored in the memory 512, the data storage 514, or the memory 512 and the data storage 514. In some embodiments, the processor 510 may fetch program instructions from the data storage 514 and load the program instructions in the memory 512. After the program instructions are loaded into memory 512, the processor 510 may execute the program instructions.

The memory 512 and the data storage 514 may include computer-readable storage media for carrying or having computer-executable instructions or data structures stored thereon. Such computer-readable storage media may include any available media that may be accessed by a general-purpose or special-purpose computer, such as the processor 510. By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other storage medium which may be used to store particular program code in the form of computer-executable instructions or data structures and which may be accessed by a general-purpose or special-purpose computer. Combinations of the above may also be included within the scope of computer-readable storage media. Computer-executable instructions may include, for example, instructions and data configured to cause the processor 510 to perform a certain operation or group of operations.

Modifications, additions, or omissions may be made to the computing system 500 without departing from the scope of the present disclosure. For example, in some embodiments, the computing system 500 may include any number of other components that may not be explicitly illustrated or described.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. Additionally, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B” even if the term “and/or” is used elsewhere.

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although embodiments of the present disclosure have been described in detail, various changes, substitutions, and alterations could be made hereto without departing from the spirit and scope of the present disclosure.

What is claimed is:

1. A hybrid optical amplifier comprising:
a first amplifier comprising:
an erbium-doped optical fiber configured to perform amplification of optical waveforms;
a first optical pump configured to output a first optical pump signal; and
a first optical coupler coupled to the first optical pump and the erbium-doped optical fiber, the first optical coupler configured to multiplex one or more optical data signals and the first optical pump signal onto the erbium-doped optical fiber; and
a second amplifier following the first amplifier, the second amplifier comprising:
a bismuth-doped optical fiber configured to perform amplification of the optical waveforms;
a second optical pump configured to output a second optical pump signal; and
a second optical coupler coupled to the second optical pump and the bismuth-doped optical fiber, the second optical coupler configured to multiplex amplified optical data signals from the first amplifier and the second optical pump signal onto the bismuth-doped optical fiber.

2. The hybrid optical amplifier of claim 1, wherein the erbium-doped optical fiber and the bismuth-doped optical fiber are configured to amplify signals within a first wavelength range.

3. The hybrid optical amplifier of claim 2, wherein a length of the erbium-doped optical fiber is adjusted such that the erbium-doped optical fiber amplifies the signals within the first wavelength range.

4. The hybrid optical amplifier of claim 3, wherein the length of the erbium-doped optical fiber is between two meters and five meters, which is adjusted to have positive gain over bandwidth of S-band of optical communications.

5. The hybrid optical amplifier of claim 2, wherein:
the first wavelength range corresponds to an S-band of optical communications.

6. The hybrid optical amplifier of claim 1, further comprising a filter coupled between the first amplifier and the second amplifier, the filter configured to attenuate noise signals outside of a first wavelength range in the amplified optical data signals from the first amplifier.

7. The hybrid optical amplifier of claim 6, wherein the filter is configured to attenuate the noise signals in a C-band of optical communications and an L-band of optical communications.

8. The hybrid optical amplifier of claim 1, wherein the second amplifier further comprises:
a third optical pump configured to generate a third optical pump signal; and
a combiner coupled between the second optical coupler, and the second optical pump and the third optical pump, the combiner configured to multiplex the second optical pump signal and the third optical pump signal onto the second optical coupler.

9. The hybrid optical amplifier of claim 8, wherein the second optical pump signal and the third optical pump signal include wavelengths shorter than 1400 nanometers (nm).

10. The hybrid optical amplifier of claim 1, wherein the bismuth-doped optical fiber is germanium (Ge)-host bismuth-doped optical fiber.

11. A method to amplify a signal comprising:
obtaining an optical signal;
obtaining a first optical pump signal from a first optical pump;
multiplexing, by a first optical coupler, the optical signal and the first optical pump signal onto an erbium-doped optical fiber, the erbium-doped optical fiber configured to perform amplification of optical waveforms within a first wavelength range to generate a first amplified optical signal;
obtaining a second optical pump signal; and
multiplexing, by a second optical coupler, the first amplified optical signal and the second optical pump signal onto a bismuth-doped optical fiber, the bismuth-doped optical fiber configured to perform amplification of the optical waveforms within the first wavelength range to generate a second amplified optical signal.

12. The method to amplify a signal of claim 11, further comprising:
prior to multiplexing, by the second optical coupler, the first amplified optical signal and the second optical pump signal onto a bismuth-doped optical fiber:
attenuating, using a filter, signals in a second wavelength range of the first amplified optical signal.

13. The method of amplify a signal of claim 12, wherein the first wavelength range corresponds to an S-band of optical communications.

14. The method of claim 13, wherein the and the second wavelength range corresponds to one or more of a C-band of optical communications or an S-band of optical communications.

15. The method to amplify a signal of claim 11, wherein a length of the erbium-doped optical fiber is adjusted such that the erbium-doped optical fiber amplifies the signals within the first wavelength range.

16. The method of claim 15, wherein the length of the erbium-doped optical fiber is between two meters and five meters.

17. The method of claim 15, wherein the length of the optical fiber is 2.5 meters.

18. The method to amplify a signal of claim 11, wherein the bismuth-doped optical fiber is germanium (Ge)-host bismuth-doped optical fiber.

19. The method of claim 11, wherein the second optical pump signal includes a combined pump signal of optical pump signals from a second optical pump and a third optical pump, the optical pump signals combined using a combiner.

20. The method of claim 19, wherein the optical pump signals from the second optical pump and the third optical pump include wavelengths shorter than 1400 nanometers (nm).
